(19) United States
(12) Patent Application Publication
(10) Pub. No.: US 2026/0221537 A1
(43) Pub. Date: Jul. 30, 2026

(54) METHOD FOR MANUFACTURING AN INTERCELL COOLING ELEMENT WITH SWELLING COMPENSATION

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 19/442,411

(22) Filed: Jan. 7, 2026

(30) Foreign Application Priority Data
Jan. 29, 2025 (DE) 102025103230.0

(51) Int. Cl. H01M 10/6557; B23P 17/04; H01M 10/613

(52) U.S. Cl. CPC H01M 10/6557; B23P 17/04; H01M 10/613

(57) ABSTRACT

A method for manufacturing an intercell cooling element with swelling compensation, includes steps of providing two metallic, in particular aluminum alloy, half-shell elements, each of which has a closed channel structure on its inner sides; aligning the half-shell elements so that the inner sides face each other, and positioning one compression insert between the half-shell elements; and connecting the half-shell elements by joining them together along their edge sections.

### FIELD

The invention relates to a method for manufacturing an intercell cooling element with swelling compensation.

### BACKGROUND

An intercell cooling element is intended for arrangement between adjacent battery cells of a driving or traction battery and is designed to cool and, if necessary, heat the corresponding battery cells, and to compensate for the so-called swelling behavior of the battery cells (also referred to as cell swelling or simply as swelling).

DE 10 2023 108 732 A1 describes an intercell cooling element with swelling compensation for arrangement between two battery cells. Also described is a method for manufacturing the intercell cooling element, in which spacer element sections are injection-molded to provide a defined minimum distance in an injection molding process, or in which the spacer element sections are formed in two parts and the section parts are clamped or joined together. Also described is an embodiment of the intercell cooling element in which at least one so-called buffer element is integrated to ensure a minimum distance.

### SUMMARY

The invention is based on the object of providing a method for manufacturing an intercell cooling element with a buffer element (hereinafter referred to as a compression insert) that can be implemented cost-effectively.

The problem is solved by the method and use of an intercell cooling element manufactured according to the invention. Additional features result analogously for both subjects of the invention from the claims, the following description of the invention (this expressly includes optional and exemplary features), and the figures.

The inventive method for manufacturing an intercell cooling element, in particular a plate-like intercell cooling element, with swelling compensation comprises at least the following steps:
providing two metallic, in particular aluminum alloy, half-shell elements, each of which has a closed channel structure on its inner sides;
aligning the half-shell elements so that their inner sides with the channel structures present thereon face each other, and positioning one, i.e. at least one, compression insert between the half-shell elements;
connecting the half-shell elements (including the compression insert) by joining them together along their edge sections, in particular along collar-like or flange-like edge sections, especially by joining them all around, wherein the joining is preferably carried out by gluing, soldering, welding and/or crimping.

The method according to the invention preferably also comprises the following previous steps:
providing an extruded profile, which means a metallic extruded profile, in particular an aluminum extruded profile, wherein the extruded profile has a flat side and a side formed with raised hollow chambers;
separating two extruded profile pieces from the extruded profile and further processing the extruded profile pieces into the half-shell elements, in particular by cutting, machining and/or forming processes.

Further processing of the extruded profile pieces can include the creation of distributor and collector regions, in particular by removing or grinding away the raised hollow chambers in the axial end regions of the extruded profile pieces.

The further processing of the extruded profile pieces can also comprise the attachment of coolant connections, more precisely coolant supply connections and coolant discharge connections, which in particular refers to pipe-like connections that are placed in the distributor and collector regions and are attached and sealed in a suitable manner, e.g. by pressing in, soldering, welding and/or gluing.

Further processing of the extruded profile pieces can also comprise the creation of circumferential collar-like or flange-like edge sections, preferably by flanging or embossing the edge regions, which can also be done in a deep-drawing tool-like press tool.

Preferably, the channel structures on the inner sides of the half-shell elements have parallel cooling channels that are offset from each other after the half-shell elements are joined. That is, the half-shell elements are prepared or provided in such a way that, after joining, the cooling channels of one half-shell element run between the cooling channels of the other half-shell element and vice versa.

The compression insert is designed to support the connected half-shells against each other flatly without affecting the channel structures or the cooling channel cross-sections, and to allow elastic deformation of the half-shells generating a counter-pressure for the purpose of swelling compensation, which in turn has a beneficial effect on the aging behavior of the battery cells. Swelling compensation is achieved without reducing or losing cooling capacity.

The compression insert, wherein multiple compression inserts may also be provided to have the same effect, is preferably made of an elastically compressible material, e.g. a plastic foam or a nonwoven fabric. Preferably, the compression insert is provided as a cut piece of a corresponding semi-finished product, which in particular refers to a flat semi-finished product.

Preferably, the completed intercell cooling element is subjected to a leak test, particularly under external pressure (to simulate the swelling behavior). The leak test is preferably carried out immediately after manufacturing.

Within the scope of the invention, both the features described above and those explained hereinafter are applicable not only in the respective combination of features specified, but also in other combinations of features or on their own. This also applies to the features shown in the figures.

In the following, the invention will be explained in greater detail with reference to figures. The features shown in the figures and/or the features explained hereinafter can be general features of the invention, even independently of specific combinations of features, and can refine the invention accordingly.

### BRIEF DESCRIPTION OF THE FIGURES

FIGS. 1 to 4 illustrate different stages of a method according to the invention for manufacturing an intercell cooling element with swelling compensation.

### DETAILED DESCRIPTION

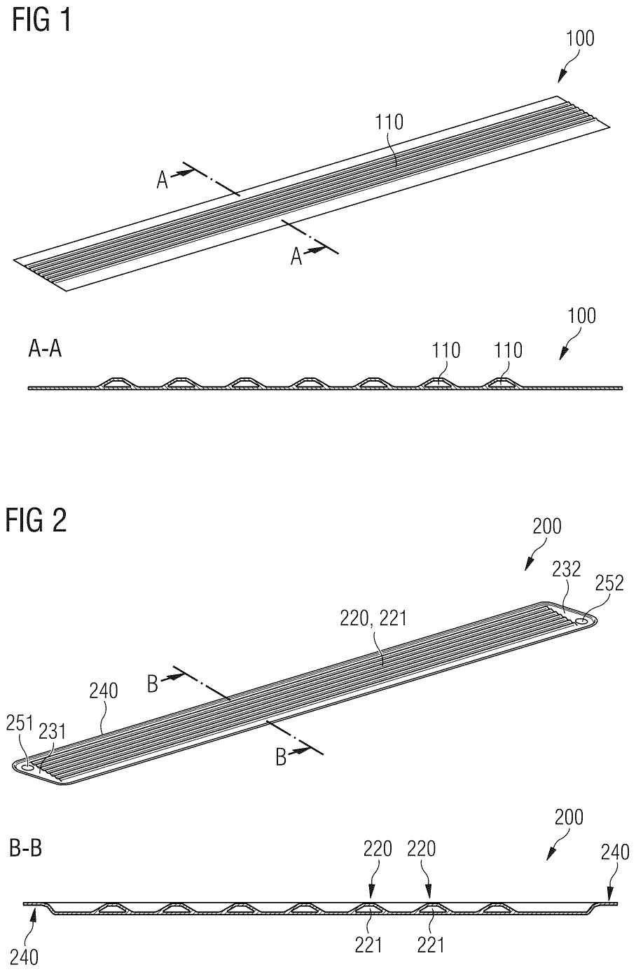

FIG. 1 shows a flat and thin-walled extruded profile piece 100 that has been cut from an extruded profile, in particular an aluminum extruded profile. As can be seen from the sectional view (A-A), the extruded profile piece 100 has a flat or smooth side and a side (opposite side) formed with raised hollow chambers 110. The hollow chambers 110 have a closed contour. The extruded profile piece 100, for example, has a wall thickness of 0.4 to 0.6 mm and a hollow chamber or channel height of 0.8 to 1.2 mm.

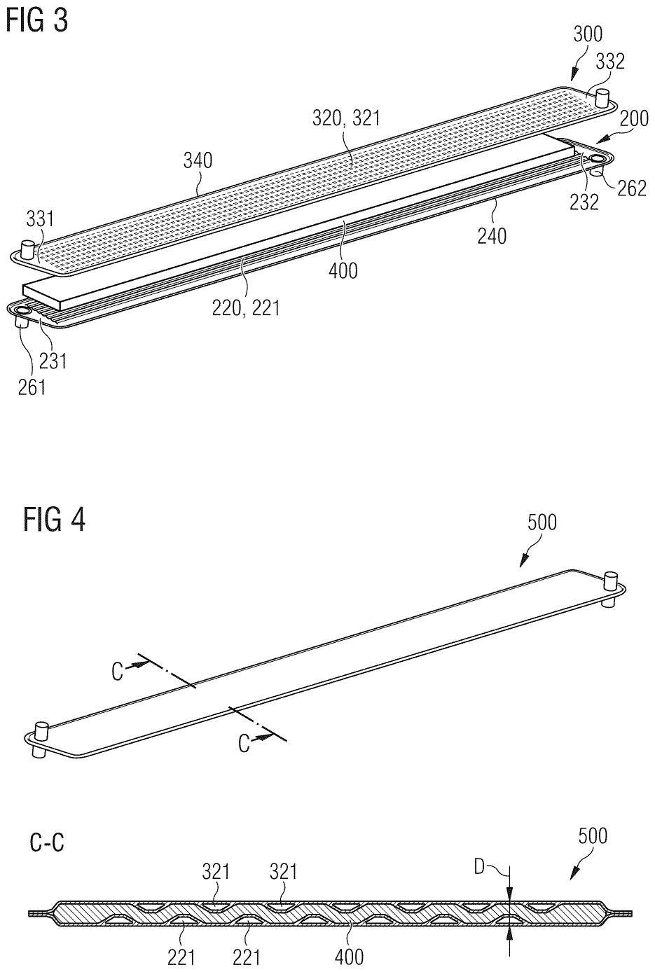

The extruded profile piece 100 is used to produce the half-shell element 200 shown in FIG. 2, which has a closed channel structure 220 emerging from the hollow chambers 110 with parallel cooling channels 221. As can be seen from the section view (B-B), the cooling channels 221 have a closed contour, i.e., the cooling channels 221 are completely enclosed in the circumferential direction. The half-shell element 200 has a distributor region 231 and a collector region 232 for the coolant in its axial end regions, for which the raised hollow chambers 110 in these regions were removed, in particular by machining. The distributor region 231 and the collector region 232 also have openings 251, 252 which are provided for the attachment of pipe-like coolant connections 261, 262 (see FIG. 3) and which were produced in particular by cutting or punching. Furthermore, the contour of the axial end regions was also adapted to the intended shape, in particular by trimming. Furthermore, the half-shell element 200 has a circumferential flange-like edge section 240, which forms a sort of collar and which was produced in particular by flanging or embossing the edge regions of the extruded profile piece 100.

FIG. 3 shows the prepared half-shell element 200 and another half-shell element 300, which is essentially mirror-symmetrical to the half-shell element 200 and is manufactured in the same way (see above). The half-shell elements 200, 300 are positioned and aligned with each other, so that the channel structures 220, 320 or the parallel cooling channels 221, 321 as well as the distributor regions 231, 331 and collector regions 232, 332 are facing each other. A compression insert 400 is positioned between the half-shell elements 200, 300. Subsequently, the two half-shell elements 200, 300 are brought into contact and joined and sealed together along their edge sections 240, 340, by enclosing the compression insert 400.

FIG. 4 shows the finished intercell cooling element 500, which has a plate-like shape. As can be seen from the section view (C-C), the closed cooling channels 221, 321 are offset from each other, as described above. The enclosed compression insert 400 extends in a meandering pattern between the cooling channels 221, 321. The outer surfaces or sides of the intercell cooling element 500 are flat and allow for a flat contact with the battery cells to be cooled. The cooling channels 221, 321 are virtually integrated into the outer walls. The intercell cooling element 500 has a small thickness D, which is, for example, only 4 to 6 mm.

The described manufacturing method offers the advantage that an extruded profile can be used as the starting material, which is readily available as a semi-finished product and has a high degree of dimensional accuracy. Furthermore, the same extruded profile can be used for both half-shell elements 200, 300. Furthermore, the joining of the circumferential flange-like edge sections 240, 340 takes place in one plane, so that the joining process, e.g. welding, can be carried out with a short cycle time.

Further features and possible embodiments of the invention are described above.

1. A method for manufacturing an intercell cooling element with swelling compensation, comprising:
providing two metallic, in particular aluminum alloy, half-shell elements, each of which has a closed channel structure on its inner sides;
aligning the half-shell elements so that the inner sides face each other, and positioning one compression insert between the half-shell elements;
connecting the half-shell elements by joining them together along their edge sections.

2. The method according to claim 1, wherein the half-shell elements are glued, soldered, welded and/or crimped together along their edge sections.

3. The method according to claim 1, further comprising the preceding steps:
providing an extruded profile, in particular an aluminum extruded profile, which has a flat side and a side formed with raised hollow chambers;
separating two extruded profile pieces and further processing the extruded profile pieces into the half-shell elements, in particular by cutting, machining and/or forming processes.

4. The method according to claim 3, wherein the further processing of the extruded profile pieces comprises the production of distributor regions and collector regions.

5. The method according to claim 3, wherein the further processing of the extruded profile pieces comprises the fitting of coolant connections.

6. The method according to claim 3, wherein the further processing of the extruded profile pieces comprises the production of circumferential flange-like edge sections.

7. The method according to claim 1, wherein the channel structures on the inner sides of the half-shell elements have parallel cooling channels that are offset from each other after the half-shell elements are joined.

8. The method according to claim 1, wherein the compression insert is made of an elastically compressible material and is provided in particular as a cut-to-size piece of a corresponding semi-finished product.

9. The method according to claim 1, wherein the completed intercell cooling element is subjected to a leak test, particularly under external pressure.

10. Use of an intercell cooling element manufactured according to a method according to claim 1 for cooling battery cells in a traction battery, wherein the intercell cooling element is arranged between the corresponding battery cells.

11. The method according to claim 2, further comprising the preceding steps:
providing an extruded profile, in particular an aluminum extruded profile, which has a flat side and a side formed with raised hollow chambers;
separating two extruded profile pieces and further processing the extruded profile pieces into the half-shell elements, in particular by cutting, machining and/or forming processes.

12. The method according to claim 4, wherein the further processing of the extruded profile pieces comprises the fitting of coolant connections.

13. The method according to claim 4, wherein the further processing of the extruded profile pieces comprises the production of circumferential flange-like edge sections.

14. The method according to claim 5, wherein the further processing of the extruded profile pieces comprises the production of circumferential flange-like edge sections.

15. The method according to claim 2, wherein the channel structures on the inner sides of the half-shell elements have parallel cooling channels that are offset from each other after the half-shell elements are joined.

16. The method according to claim 3, wherein the channel structures on the inner sides of the half-shell elements have parallel cooling channels that are offset from each other after the half-shell elements are joined.

17. The method according to claim 4, wherein the channel structures on the inner sides of the half-shell elements have parallel cooling channels that are offset from each other after the half-shell elements are joined.

18. The method according to claim 5, wherein the channel structures on the inner sides of the half-shell elements have parallel cooling channels that are offset from each other after the half-shell elements are joined.

19. The method according to claim 6, wherein the channel structures on the inner sides of the half-shell elements have parallel cooling channels that are offset from each other after the half-shell elements are joined.

20. The method according to claim 2, wherein the compression insert is made of an elastically compressible material and is provided in particular as a cut-to-size piece of a corresponding semi-finished product.
